(19) United States
(12) Patent Application Publication
(10) Pub. No.: US 2025/0139533 A1
(43) Pub. Date: May 1, 2025

(54) MACHINE-LEARNING-BASED UNSUPERVISED DATA CORRECTION

(71) Applicant: SAP SE, Walldorf (DE)

(72) Inventor: Evgeny Arnautov, Stutensee (DE)

(73) Assignee: SAP SE, Walldorf (DE)

(21) Appl. No.: 19/012,761

(22) Filed: Jan. 7, 2025

Related U.S. Application Data
(63) Continuation of application No. 17/216,027, filed on Mar. 29, 2021.

(51) Int. Cl. G06N 20/00; G06F 12/0888; G06F 16/215; G06F 18/10; G06F 18/22; G06F 40/20; G06F 40/40; G06N 3/09

(52) U.S. Cl. CPC G06N 20/00; G06F 12/0888; G06F 16/215; G06F 18/10; G06F 18/22; G06F 40/20; G06F 40/40; G06N 3/09; G06F 2212/45

(57) ABSTRACT

Technologies are described for correcting data, such as master data, in an unsupervised manner using supervised machine learning. Correction of master data can involve receiving a table containing unlabeled master data. Machine learning models are applied to the fields of one or more columns of the table to predict values of the fields, and the machine learning models use unsupervised learning. For example, a machine learning model can be applied to a particular field of a particular column to predict the value of the particular field. The machine learning model uses the fields of other columns as features. Results of applying the machine learning models include indications of recommended values, indications of probabilities of the recommended values, and indications of which original values do not match their respective recommended values. The results can be used to perform manual and/or automatic correction of the master data.

### CROSS REFERENCE TO RELATED APPLICATIONS

This application is a continuation of U.S. patent application Ser. No. 17/216,027, filed Mar. 29, 2021, which is hereby incorporated herein by reference.

### BACKGROUND

Organizations relay on master data for various types of business processes. The quality of master data is particularly important in carrying out the transactions performed by an organization as the master data provides the context for the transactions.

Maintenance of master data can be difficult for an organization. The difficulty increases with the amount of master data to be maintained (e.g., the number of products or customers supported by the organization). For example, master data may contain errors, such as outdated values, inconsistent values, or typos. Typically, an organization manually reviews and corrects master data in its systems. Manual review and correction of master data is time consuming and error prone.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various technologies are described herein for unsupervised master data correction using supervised machine learning. Correction of master data can involve receiving a table containing master data (e.g., comprising a plurality of columns and a plurality of rows), where the table of master data is received as unlabeled data. Machine learning models are applied to the fields of one or more selected columns of the table to predict values of the fields, and the machine learning models use supervised learning. For example, a machine learning model can be applied to a particular field of a particular column to predict the value of the particular field. The machine learning model uses the fields of other columns as features. Results of applying the machine learning models include indications of recommended values, indications of probabilities of the recommended values, and indications of which original values do not match their respective recommended values. The results can be used to perform manual and/or automatic correction of the master data.

### BRIEF DESCRIPTION OF THE DRAWINGS

FIG. 1) is a diagram depicting an example environment for performing unsupervised master data correction using supervised machine learning models.

FIG. 2) is a diagram depicting an example table of master data, including selection of columns for processing using supervised machine learning.

FIG. 3) is a diagram depicting example results of applying machine learning models, including recommended values for the fields of selected columns.

FIG. 4) is a diagram depicting example results of applying machine learning models, including probabilities of recommended values for the fields of selected columns.

FIG. 5) is a diagram depicting example results of applying machine learning models, including indications of which original values do not match their respective recommended values.

FIG. 6) is a is a flowchart of an example method for performing unsupervised correction of master data using supervised machine learning.

FIG. 7) is a is a flowchart of an example method for performing unsupervised correction of master data using supervised machine learning.

FIG. 8) is a diagram of an example computing system in which some described embodiments can be implemented.

FIG. 9) is an example cloud computing environment that can be used in conjunction with the technologies described herein.

### DETAILED DESCRIPTION

### Overview

The following description is directed to technologies for unsupervised master data correction using supervised machine learning. Correction of master data can involve receiving a table (e.g., a database table) containing master data, where the table of master data is received as unlabeled data. The table has a number of columns and a number of rows. Machine learning models are applied to the fields of one or more selected columns of the table to predict values of the fields, and the machine learning models use supervised learning. For example, a machine learning model can be applied to a particular field of a particular column to predict the value of the particular field. The machine learning model uses the fields of other columns as features. Results of applying the machine learning models include indications of recommended values, indications of probabilities of the recommended values, and indications of which original values do not match their respective recommended values. The results can be output for display to a user via a computer user interface (e.g., a graphical user interface or GUI). In some implementations, the results are output in the format of three tables, one depicting the indications of recommended values, one depicting the indications of probabilities, and one depicting indications of which original values do not match their respective recommended values. The results can be used to perform manual and/or automatic correction of the master data.

The term master data refers to data describing stable entities. In other words, master data is data defining the entities or objects that give context to activities performed by an organization. Typically, master data does not change frequently. Examples of master data include, but are not limited to, data representing products, customers, vendors, costs, assets, etc. Master data is different from transactional data (e.g., data that is generated by some action that is performed by an organization, such as generated by a sales order or invoice).

Maintenance of master data can be difficult for an organization. In addition, the difficulty of managing master data increases with the size of the master data (e.g., the number of records of master data that are maintained, such as the number of products, customers, etc.). In typical scenarios, checking and correcting master data is a manual activity performed by people. Due to the amount of master data that is often used within an organization, performing such manual checking and correction can be time consuming and error prone, and in many cases, it can be impractical to perform manual review of master data.

The master data correction technologies described herein use an unsupervised machine learning approach. Unsupervised learning is different from supervised learning. With supervised learning, a machine learning model is trained with training data. Training data is data that is labeled by a person (e.g., training examples comprising desired input and output that is labeled by a person). Obtaining training data can be a roadblock to using supervised learning (e.g., obtaining or generating training can be a time consuming and difficult process). In contrast, unsupervised learning does not use labeled data and does not require training with labeled data.

Using an unsupervised approach to master data correction provides a number of advantages. Primarily, the unsupervised master data correction technologies are applied without having to train the machine learning models explicitly and without using training data that has been labeled. In other words, the data that is provided by the user (e.g., a table of master data) is unlabeled data (i.e., the user does not label the data). For example, a user managing a collection of master data (e.g., a database administrator managing a database system comprising master data, such as master data describing materials, customers, vendors, products, prices, etc.) can use the master data correction technologies without having to generate training data that involves labeling training examples. This unsupervised approach to master data correction saves time (e.g., the user does not label the data or provide training data) and computing resources.

The unsupervised master data correction technologies described herein can be applied to automatically identify problems with master data and automatically recommend correct values for any values identified as likely incorrect (e.g., above a threshold confidence level). For example, the described technologies can be applied to extract patterns from the master data using supervised machine learning. Master data that does not follow the extracted patterns can be identified as potentially incorrect (e.g., based on probabilities). Using results, master data can be corrected, either automatically or manually.

### Input Data

The technologies described herein for correcting master data are applied to a table of master data that is provided as input to the procedure. The table of master data can be a portion of master data that is stored in a database or other type of data store. The table of master data is organized into columns and rows. Typically, there are three types of structured data that can be present in the table of master data, and each column corresponds to one of the three types. The first type is text (e.g., product descriptions), which is also called free text. The second type is categorical (e.g., product categories or sub-categories). Categorical data identifies a finite number of discrete categories or classes. The third type is numerical (e.g., product prices).

The table of master data that is provided as input to the procedures is unlabeled data. This means that the user does not label the data, and there is no explicit labeling of the data.

In some implementations, only specific types of columns can be analyzed using supervised machine learning to detect potential errors. Specifically, depending on the type of supervised machine learning used, it may only be possible to effectively analyze columns containing categorical data and/or columns containing numerical data. Therefore, depending on the implementation, only columns containing categorical and/or columns containing numerical data will be available. Other types of columns, such as columns containing text data (also referred to as free text), can still be used as features for the supervised machine learning algorithm.

In some implementations, the user selects which columns will be analyzed to detect potential errors. For example, the user could use a computer user interface to select one or more categorical and/or numerical columns of a table of master data for analysis. In some implementations, the columns are selected automatically without user intervention. For example, all columns of the table of master data that contain categorical data (also referred to as categorical columns) and/or all columns of the table of master data that contain numerical data (also referred to as numerical columns) can be selected. In some implementations all eligible columns of a table of master data are automatically selected for analysis (i.e., all categorical and all numerical columns).

### Unsupervised Machine Learning Approach

The technologies described herein for correcting master data are performed by applying machine learning models to fields of columns of master data using an unsupervised machine learning approach. The unsupervised machine learning approach is an approach that is unsupervised from the point of view of the user that is providing the data (e.g., the table of master data) and receiving the results. In other words, the user performs correction of master data in unsupervised manner using unlabeled data. For example, a machine learning model can be applied to each field of each selected column of master data. Prediction of given field of a given column involves applying the machine learning model to the given field using other columns as features (in addition to the other fields of the given column). In some implementations, the machine learning model uses pattern matching techniques to predict the value of the given field.

Various types of machine learning models can be used. In some implementations, the machine learning models use supervised ensemble methods, such as random forest.

For each field that will be predicted using a machine learning model, the fields of other columns are used as features for the machine learning model. Other columns can be used as features regardless of whether they are categorical columns, numerical columns, or text columns.

When columns containing text data are used as features, additional processing can be performed prior to using them as input to the machine learning models. In some implementations, the text data is processed using one or more natural language processing (NLP) techniques. In some implementations, the Bidirectional Encoder Representations from Transformers (BERT) NLP technique is used. The NLP processing techniques are applied to the text data to extract representations from the text data. The representations are combined with other non-text features and used as inputs to the machine learning models (e.g., random forest).

In some implementations, pre-processing is applied to the features (e.g., to each input feature). In some implementations, numerical data is pre-processed using normalization and/or standardization. In some implementations, categorical data is pre-processed using hashing or one-hot encoding.

In some implementations, pre-processed features are cached for use by subsequent machine learning models. Caching feature data saves computing resources because the pre-processing is only performed once, and the cached feature data is then re-used when predicting other fields.

### Results of Applying Machine Learning Models

In the technologies described herein, machine learning models are applied to master data in an unsupervised way, and results of applying the machine learning models are generated. Generally, the results predict the values of the fields being investigated.

In some implementations, the results comprise indications of recommended values for the fields of the selected column or selected columns. The recommend value for a given filed of a selected column is the value that is determined by the machine learning model as the most likely value for the field. For categorical fields, the recommended value is the category identified by the machine learning model as the most likely category for the field. For numerical fields, the recommend value is the numerical value identified by the machine learning model as the most likely numerical value for the field. The recommended value for each field of the selected column(s) can be output (e.g., displayed, saved, etc.).

In some implementations, the results comprise indications of probabilities (also referred to as confidence or confidence levels) of the recommended values for the fields of the selected column or selected columns of categorical type. A probability for a given field indicates how confident the machine learning model is in its predicted value for the given field. The probability can be represented as a percentage (e.g., 96% or 0.96) or using another representation. The probability for each field of the selected column(s) can be output (e.g., displayed, saved, etc.). In some implementations, the probabilities are reported differently for categorical versus numerical columns. Specifically, for categorical columns, the probabilities indicate how confident the machine learning model is in the recommended value (e.g., 75%, 90%, and so on). However, with numerical columns, the probabilities indicate the discrepancy between the predicted value and the original value, which can be calculated by: 100*|predicted−initial|/initial. For example, if a price value is predicted to be $30 and the initial value is $18, then the calculated discrepancy would be 67%.

In some implementations, the results comprise indications of which original values of the fields of the selected column(s) do not match their respective recommended values. For example, if a given field has an original (input) value of “health and beauty” (for a categorical column), and the machine learning model predicts a value of “video games” for the given field, then the indication would be that the predicted and original field values do not match. However, if the machine learning model predicts a value of “health and beauty” for the given field, then the indication would be that the predicted and original field values match. Similar indications can be generated for numerical fields (e.g., an original price of $19.99 does not match a predicted price of $179.99). The indication can be output with labels of true (the values match) or false (the values do not match, also referred to as a mismatch indicator). The indications for each field of the selected column(s) can be output (e.g., displayed, saved, etc.), or the indications can be output for just the fields that do not match.

In some implementations, one or more of the above indications are generated and/or output in the form of one or more respective tables. For example, a first table can be generated comprising the indications of recommended values for the fields (e.g., recommended categories and/or numerical values) of the selected column or selected columns, a second table can be generated comprising indications of probabilities of the recommended values for the fields (e.g., percentages and/or discrepancies) of the selected column or selected columns, and/or a third table can be generated comprising indications of which original values of the fields (e.g., as true/false identifiers) of the selected column(s) do not match their respective recommended values. In some implementations, each of the tables have the same dimensions as the selected columns(s). For example, if there are three selected columns, each having six rows, then each table of results can have three columns and six rows.

Action can be taken to correct master data based on the results. In an example scenario, a user could view the results and make corrections based on the recommended values and probabilities. For example, if the user sees that the machine learning model is 90% confident in a particular value for a categorical field, and the particular value is different from the original value for the categorical field, then the user can change the categorical field to the predicted value. The user could base the decision, at least in part, on the probability (e.g., if the probability is above a threshold probability, such as 90% or 95%, then the user can change to the recommended value). Similarly, the user could change a particular value of a numerical field based on the discrepancy (e.g., if the discrepancy is above a threshold discrepancy, such as 10% or 15%, then the user can change to the recommended value).

Action to correct master data based on results can also be an automated process. In other words, master data can be corrected automatically, without user intervention. In some implementations, if a recommended value is different from an original value for a given categorical field, then the probability is checked. If the probability is above a threshold probability (e.g., above 90% in some implementations), then the given categorical field is changed to the recommended value. If the given field is a numerical field, then the change to the recommended value is performed based on the discrepancy in comparison to a discrepancy threshold (e.g., above 10% in some implementations).

In some implementations, a hybrid approach is applied to correcting master data based on the results. The hybrid approach applies automated correction for values with confidence or discrepancy in a first range, provides results for manual review for values in a second range, and does not provide results for values in a third range. For example, automatic correction can be performed in the first range for values with confidence above a first confidence threshold (e.g., 95%) or discrepancy above a first discrepancy threshold (e.g., 15%). Values can be provided for manual review in the second range for values with probability between a second probability threshold and the first probability threshold (e.g., between 70% and 95%) or discrepancy between a second discrepancy threshold and the first discrepancy threshold (e.g., between 10% and 15%). Values below the second range can be ignored (e.g., not provided automatic correction or manual review). However, manual review could still be performed for values in the third range.

### Example Environments for Correcting Master Data Using an Unsupervised Machine Learning Approach

In the technologies described herein, environments can be provided for performing master data correction using an unsupervised machine learning approach. The environments can include computing resources (e.g., computing devices such as desktops, servers, etc., database resources, cloud computing resources, and/or other types of computing resources).

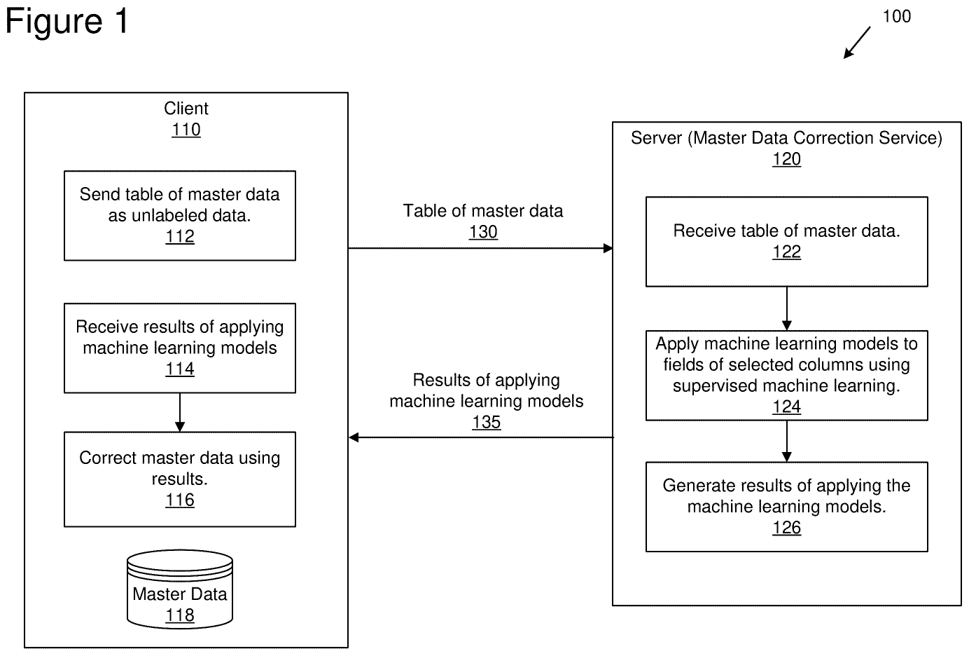

FIG. 1 is a diagram depicting an example environment 100 for performing unsupervised master data correction using supervised machine learning. The example environment 100 depicts a client 110. The client 110 can be any type of computing hardware and/or software that is configured (e.g., running computer-executable instructions) to perform operations implementing the technologies described herein. The client 110 can run on various types of computing resources (e.g., a server computer, desktop computer, laptop computer, smart phone, virtual computer, or another type of computing device).

The example environment 100 depicts a server 120. The server 120 can be any type of computing hardware and/or software that is configured (e.g., running computer-executable instructions) to perform operations implementing the technologies described herein. The server 120 can be implemented using various types of computing resources (e.g., server resources, database resources, storage resources, cloud computing resources, etc.).

In the example environment 100, the client 110 provides a local environment for managing master data (e.g., from a master data database 118 or from another type of data store). For example, a database administrator or other user uses a computer user interface to perform at least some of the depicted operations. At 112, the client 110 sends a table containing master data (e.g., from the master data database 118) to the server 120, as depicted at 130. For example, a user of the client 110 could use a computer user interface to select the master data for sending to the server 120 (e.g., select a portion of the master data from the master data database 118). The table of master data that is sent by the client 110 is unlabeled data. This means that the user does not label the master data. From the point of view of the client 110, and users (e.g., database administrators) of the client 110, this is an unsupervised machine learning approach. This is different from a traditional supervised machine learning approach where the user manually labels the data to be used for training the machine learning model(s).

At 122, the server 120 receives the table of master data from the client 110. The table of master data is received as unlabeled data. At 124, the server 120 applies machine learning models to fields of selected columns of the received master data using an unsupervised machine learning approach. For example, the server 120 trains one machine learning model, using the received unlabeled data, for each of the selected columns. When training a given machine learning model for a given column, the server 120 trains the machine learning model using supervised learning (with a supervised machine learning algorithm, such as random forest) and uses the given column as the label and the other columns as the features. In this way, the server 120 can train the machine learning models using only the received unlabeled data (implicitly using each of the selected columns, in turn, as labels), run the machine learning models to perform the prediction, and discard the machine learning models afterwards. In some implementations, the selected columns are selected by a user (e.g., the user of the client 110). For example, the client may want to check only certain columns of master data for errors. In some implementations, the selected columns are selected automatically (e.g., all columns of the table of master data can be selected for analysis, or only columns containing certain types of data, such as columns containing categorical data and/or columns containing numerical data).

At 126, the server 120 generates results of applying the machine learning models. The results can comprise indications of recommended values for the fields of the selected columns, indications of probabilities of the recommended values for the fields of the selected columns, and/or indications of which original values of the fields of the selected columns do not match their respective recommended values. In some implementations, the results are generated in a table format (e.g., one or more tables with the same dimensions as the table of master data). The results are returned to the client 110, as depicted at 135.

At 114, the client 110 receives the results of applying the machine learning models. At 116, the client 110 corrects the master data using the results. In some implementations, the client 110 provides a computer user interface for display to a user to display the results and perform the correction. For example, the client 110 can provide indications of recommended values for the fields of the selected columns, indications of probabilities of the recommended values for the fields of the selected columns, and/or indications of which original values of the fields of the selected columns do not match their respective recommended values for display in the computer user interface (e.g., in the format of tables and/or in another format). The user can review the displayed results and decide which fields of master data to correct. The user can then perform the correction (e.g., select specific fields to be automatically updated in the master data database 118). In some implementations, the client 110 automatically performs the master data correction (e.g., automatically corrects master data using the recommended values). For example, the client 110 can automatically correct those fields of master data that have recommended values different from their original values and for which the probability is above a threshold value.

In some implementations, a user performs at least some of the client operations depicted at 112, 114, and 116. For example, the user can be a database administrator that uses a computer user interface to select a table of master data (e.g., from the master data database 118) for sending to the server 120 as unlabeled data. The user can view a display of the results of applying the machine learning models and select specific fields to be corrected. In some implementations, the operations at the client 110 are automated and performed without user intervention. For example, the operations can be performed as a fully automated procedure in which a table of master data is automatically selected and sent to the server 120 as unlabeled data for analysis. Results can be automatically processed, and corrections can be automatically applied to the master data (e.g., automatically updating the master data database 118).

In some implementations, the client 110 accesses the server 120 as a cloud service. For example, the client 110 can be in a remote location and access the cloud service via a computer network (e.g., via the Internet). In some implementations, the client 110 accesses the server 120 via an application programming interface (API) and/or via a web service.

The example environment 100 depicts an example client-server arrangement for implementing the technologies described herein for correcting master data. However, the technologies do not have to be performed using a client-server arrangement. For example, a single computing environment (e.g., a local collection of computing resources) could perform all of the operations (e.g., all operations could be performed at the client 110, which could be a database server).

### Example Unsupervised Master Data Correction Scenario

In the technologies described herein, unsupervised master data correction can be performed as an automated process and/or as a manual process. For example, an automated process can comprise automatically determining which columns of master data are selected for review (e.g., automatically determining that all categorical and/or numerical columns are to be selected for review). The selected columns can then be processed using machine learning models, results can be generated, and corrective action can be taken (e.g., values can be automatically corrected based on thresholds). A manual process can comprise selecting which columns of master data are to be reviewed (e.g., by a user via a computer user interface). The selected columns can be provided for automated processing (e.g., sent to a master data correction service) where machine learning models are applied to generate results. Results can be received and presented (e.g., to the user via the computer user interface) and corrective action can be taken (e.g., the user can review the results, including recommended values and probabilities, and correct master data based on the results).

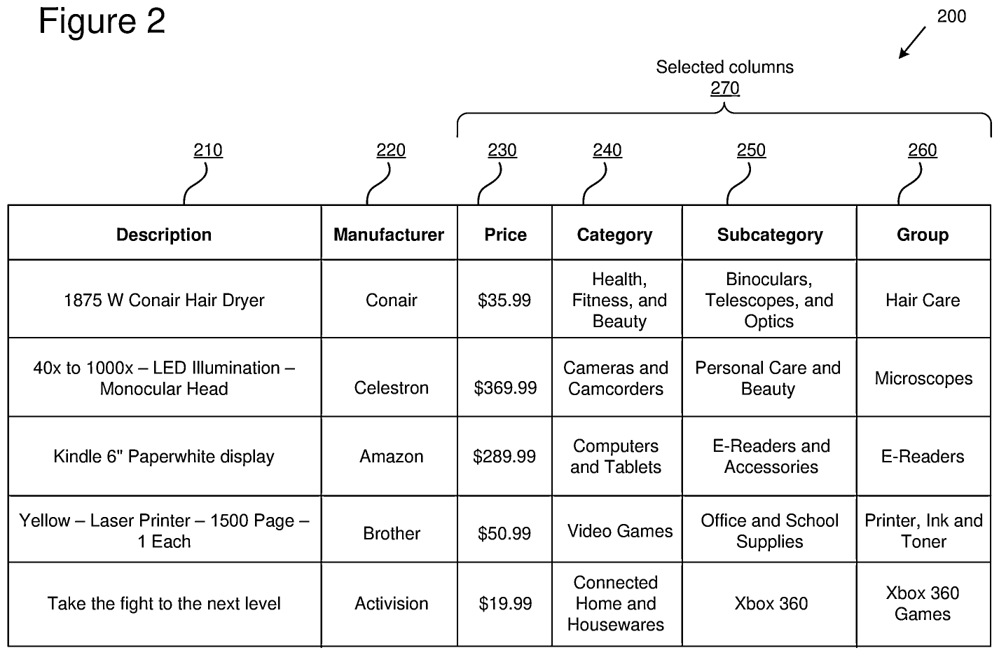

FIG. 2 is a diagram depicting an example table of master data 200, including selection of columns for processing in an unsupervised way using supervised machine learning. The table of master data 200 includes example data for six rows and five columns containing data for various consumer products. The columns include a description column 210, a manufacturer column 220, a price column 230, a category column 240, a subcategory column 250, and a group column 260. The columns are a mix of free text columns, numerical columns, and categorical columns. Specifically, the manufacturer column 220, category column 240, subcategory column 250, and group column 260 are categorical columns that contain categorical data. For example, the category column 240 contain the category for a given product, where the category is selected from a predefined set of available categories. The price column 230 is a numerical column containing numerical data, which in this example table is the retail price of the products. The description column 210 is a free text column containing text that describes the products.

In this example scenario, the user has selected a number of columns for performing unsupervised master data correction. Specifically, the user has selected the price column 230, the category column 240, the subcategory column 250, and the group column 260, as depicted at 270. In other scenarios, different columns can be selected. For example, an automated selection process could select all categorical columns (manufacturer column 220, category column 240, subcategory column 250, and group column 260) and/or all numerical columns (price column 230). While the user can select columns for performing unsupervised master data correction, the user does not label any of the data.

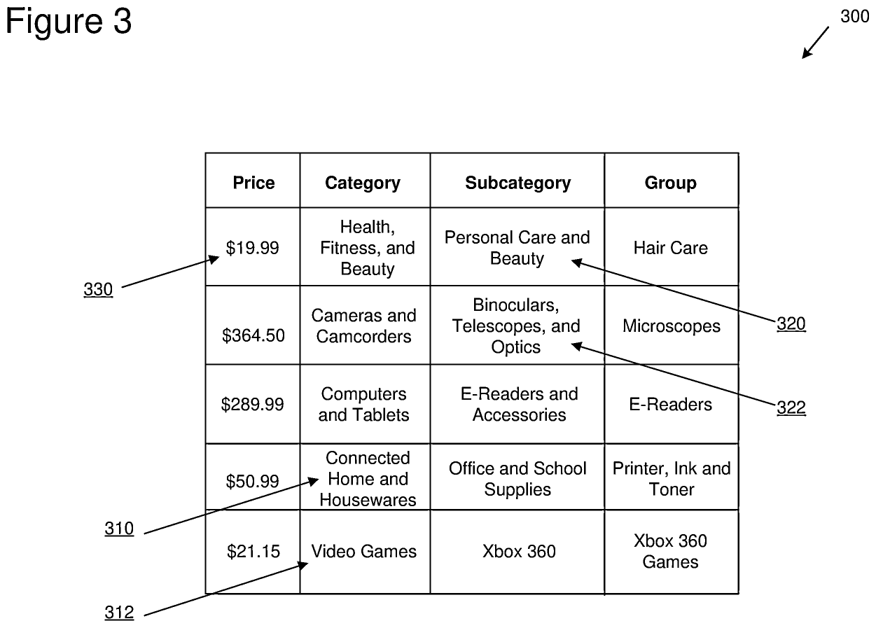

FIG. 3 is a diagram depicting example results 300 of applying machine learning models using an unsupervised approach, including recommended values for the fields of selected columns. Specifically, the example results 300 depict recommended values for the selected columns of the example table of master data 200. In the example results 300, there are a number of recommended values that do not match their respective initial values (the initial values, also called input values, from the example table of master data 200). Specifically, there are two category column fields that do not match their original values, as depicted at 310 and 312. For example, the machine learning model has determined a recommended value for one of the category column fields of “Connected Home and Housewares,” as depicted at 310. This value is different that the initial value for this field, which was “Video Games,” as depicted in the example category column 240. In addition, there are two subcategory column fields whose values do not match their original values, as depicted at 320 and 322. Finally, the recommended values for the price column are depicted, which are generally similar to the initial values. However, there is one values that is significantly different, which is depicted at 330.

In some implementations, the machine learning model uses various machine learning techniques, such as pattern matching and/or clustering techniques, to predict the value of the given field. Using the “Video Games” field as an example (the field in category column 240 for the Brother laser printer product), the machine learning model predicts this field using the other columns as features (in addition to the other fields of the category column 240). In a typical scenario, there would be many more (e.g., hundreds, thousands, or more) products in the table of master data. Therefore, the machine learning model would be able to predict the category for the Brother laser printer using other products with similar features (e.g., based on other laser printers or similar products, and taking into account their categories, subcategories, manufacturers, prices, and/or descriptions). For example, the machine learning model may recognize that other laser printers (or other printers in general) are in the “Connect Home and Housewares” category, and not in the “Video Games” category. Therefore, the machine learning model may be able to predict, with a certain degree of confidence, that the category field for the Brother laser printer should be “Connected Home and Housewares.”

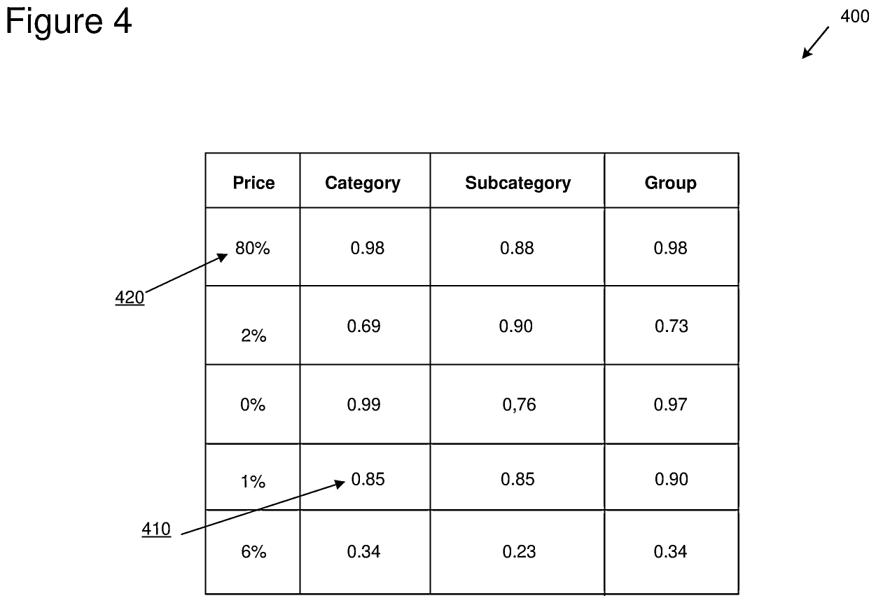

FIG. 4 is a diagram depicting example results 400 of applying machine learning models, including probabilities of recommended values for the fields of selected columns. Specifically, the example results 400 depict probabilities of the recommended values for the selected categorical columns (as depicted in FIG. 3) of the example table of master data (as depicted in FIG. 2). For example, the value of 0.85 depicted at 410 indicates that the machine learning model is 85% confident in its recommended “Connected Home and Housewares” category value for this field. For the selected numerical column (the price column in this scenario), discrepancies are depicted. For example, the 80% discrepancy value depicted at 420 represents the discrepancy between the initial value of $35.99 and the recommended value of $19.99 for this field. In general, discrepancies can be more helpful when determining whether a numerical value should be changed (e.g., in comparison to a threshold).

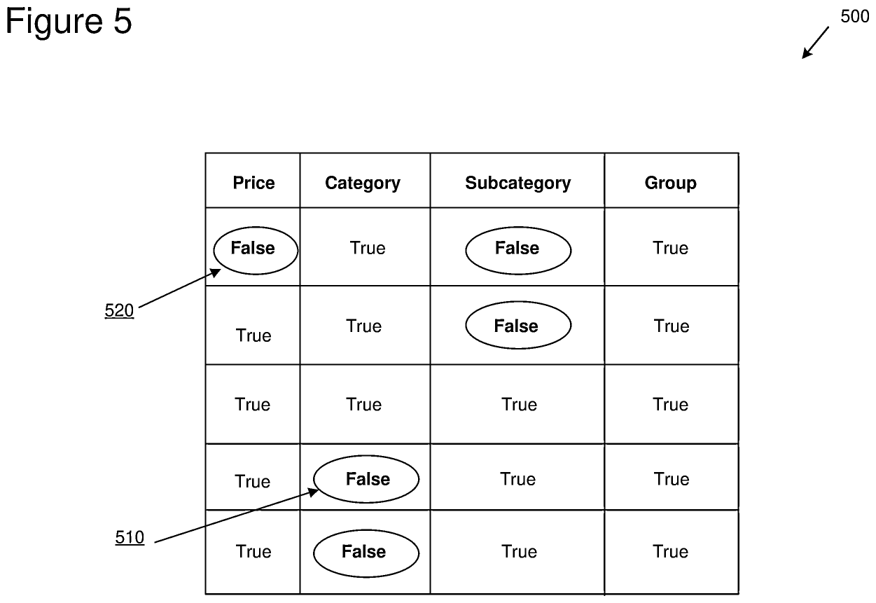

FIG. 5 is a diagram depicting example results 500 of applying machine learning models using an unsupervised machine learning approach, including indications of which original values do not match their respective recommended values. Specifically, the example results 500 depict which recommended values, as depicted in the example results 300, do not match their respective initial values, as depicted in the table of master data 200. An indication of “true” for a given field means that the field's initial value matches its recommended value, and an indication of “false” means that the field's initial value does not match its recommended value. For categorical field values, a direct comparison between initial and recommended values is performed. For example, the indication depicted at 510 is false because the initial value for this field is “Video Games,” which does not match the recommend value of “Connected Home and Housewares” for this field. For numerical field values, the indication depends on the discrepancy threshold. In this scenario, the discrepancy threshold is set to 10%. Therefore, there is only one field of the price column with a discrepancy above the discrepancy threshold, which is the field depicted at 520 (which has a discrepancy of 80%, as depicted at 420).

In this scenario, the results can be presented to a user via a computer user interface. For example, one or more of the example results 300, 400 and/or 500 can be displayed to the user in a computer user interface (e.g., in a table format or in another format). The user can use the results to correct master data. For example, the user can review the indications depicted in example results 500 to identify which fields have non-matching values (in this scenario, the fields that are marked as “false”). The user can then review the probabilities depicted in example results 400. If a given probability is relatively high (e.g., based on the user's judgment, which could include comparing the given probability to a probability threshold and/or considering other factors), then the user can change the field value to the recommended field value. For numerical fields, the user can change the field value if the discrepancy is relatively high (e.g., based on the user's judgment, which could include comparing the discrepancy to a discrepancy threshold and/or considering other factors).

In some implementations, the results can be used to automatically make corrections to the master data. For example, if a given categorical field's recommend value does not match its initial value, and its probability is above a probability threshold, then the field's value can be automatically changed to the recommended value. If a given numerical field's discrepancy value is greater than a discrepancy threshold, then the field's value can be automatically changed to the recommended value.

In this scenario, the example results 300, 400 and 500 are presented in table format. However, the results can be presented in any format. For example, the results can be presented as a list of fields containing only those fields whose recommended values do not match their initial values.

### Methods for Performing Unsupervised Correction of Master Data

In the technologies described herein, methods can be provided for performing correction of master data in an unsupervised manner using supervised machine learning. For example, the methods can be implemented by a master data correction service (e.g., implemented by server 120).

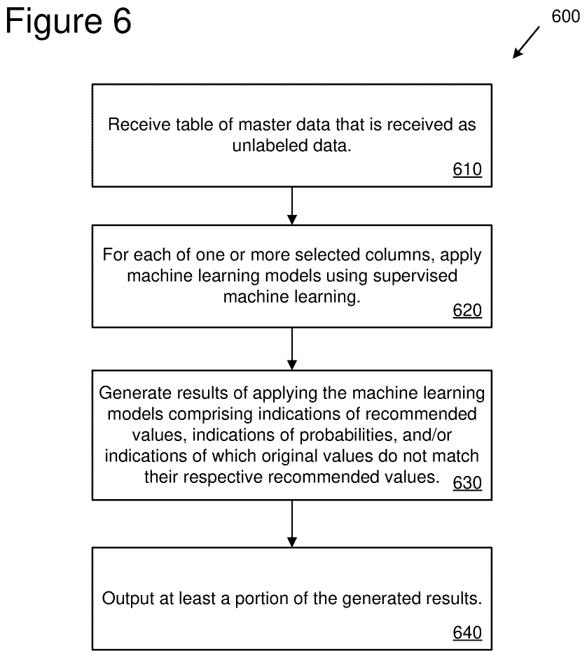

FIG. 6 is a flowchart depicting an example process 600 for performing unsupervised correction of master data using supervised machine learning. In some implementations, a computing device (e.g., server 120) is programmed with computer instructions to implement an algorithm as described by FIG. 6.

At 610, a table of master data is received. The table of master data comprises a plurality of columns and a plurality of rows. The table of master data is received as unlabeled data. An example table of master data is depicted in FIG. 2.

At 620, machine learning models are applied for each of one or more selected columns of the master data. In some implementations, the selected columns are determined automatically (e.g., all eligible columns are selected, which can be all columns containing categorical data and/or all columns containing numerical data). In some implementations, the selected columns are selected manually. For example, a user can select one or more categorical columns and/or one or more numerical columns to check for potentially incorrect master data. Each of the selected columns is processed by applying a machine learning model to the fields of the selected column. The machine learning model uses supervised machine learning, and the machine learning model predicts values of the fields of the selected column. The machine learning model uses other columns (including columns not selected for prediction) as features for the machine learning model.

At 630, results of applying the machine learning models are generated. The results comprise indications of recommended values for the fields of the selected columns, indications of probabilities of the recommended values for the fields of the selected columns, and/or indications of which original values of the fields of the selected columns do not match their respective recommended values. In some implementations, the indications for numerical columns comprise discrepancies (e.g., in addition to, or instead of, probabilities).

At 640, at least a portion of the generated results are output. For example, the results can be output for display to a user via a computer user interface (e.g., in the format of tables). The results can also be used by an automated process to correct the master data.

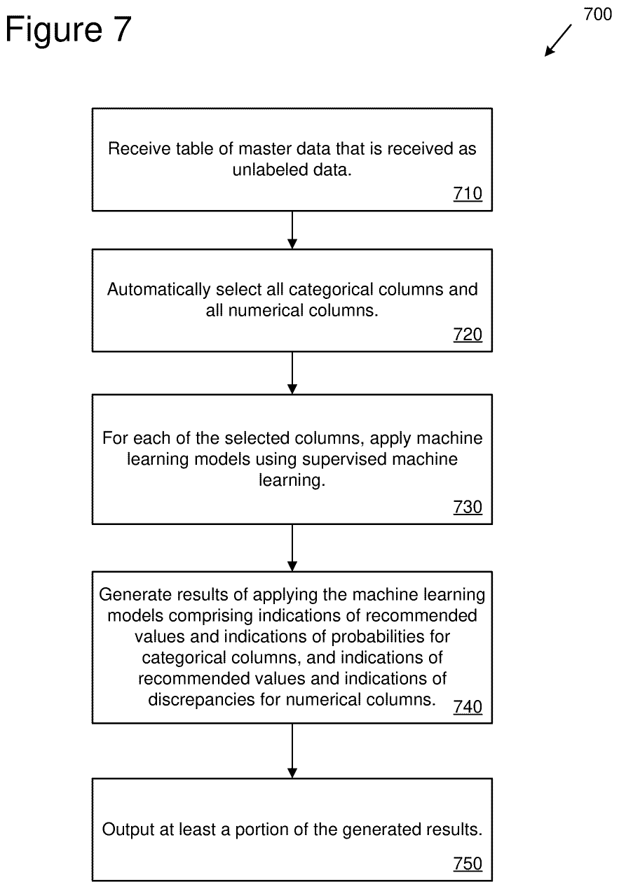

FIG. 7 is a flowchart depicting an example process 700 for performing unsupervised correction of master data using supervised machine learning. In some implementations, a computing device (e.g., server 120) is programmed with computer instructions to implement an algorithm as described by FIG. 7.

At 710, a table of master data is received. The table of master data comprises a plurality of columns and a plurality of rows. The table of master data is received as unlabeled data. An example table of master data is depicted in FIG. 2. At 720, all categorical columns and all numerical columns of the table of master data are automatically selected. Other columns in the master data, such as columns containing free text, are not selected. Alternatively, the selected columns can be determined manually (e.g., a user can select one or more categorical columns and/or one or more numerical columns to check for potentially incorrect master data).

At 730, machine learning models are applied for each of the selected columns of the master data. Each of the selected columns is processed by applying a machine learning model to the fields of the selected column. The machine learning model uses supervised machine learning, and the machine learning model predicts values of the fields of the selected column. The machine learning model predicts values of the fields of the selected column by implicitly using the fields of the selected column as labels (i.e., there are no labels specified in the received table of master data, so the machine learning model uses the fields of the selected column as labels). The machine learning model uses other columns (including columns not selected for prediction) as features for the machine learning model. In some implementations, upon receiving the table of master data, a machine learning model is trained and run for each of the selected columns.

At 740, results of applying the machine learning models are generated. The results that are generated depend on the date type of the selected column. For categorical columns, the results comprise indications of recommended values and indications of probabilities of the recommended values. For numerical columns, the results comprise indications of recommended values and indications of discrepancies between original values and the recommended values.

At 750, at least a portion of the generated results are output. For example, the results can be output for display to a user via a computer user interface (e.g., in the format of tables). The results can also be used by an automated process to correct the master data.

### Computing Systems

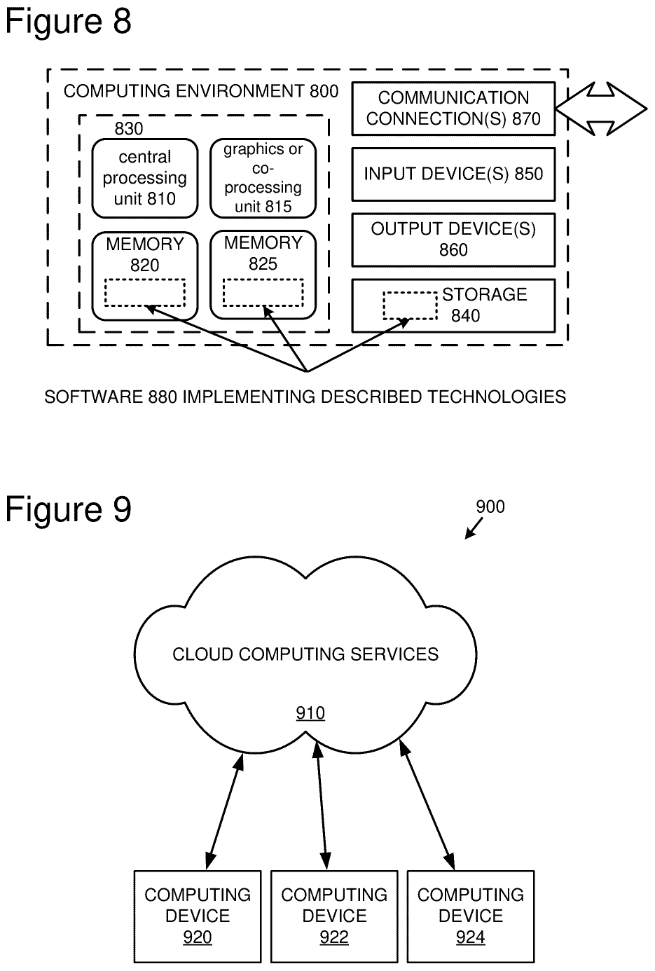

FIG. 8 depicts a generalized example of a suitable computing system 800 in which the described innovations may be implemented. The computing system 800 is not intended to suggest any limitation as to scope of use or functionality, as the innovations may be implemented in diverse general-purpose or special-purpose computing systems.

With reference to FIG. 8, the computing system 800 includes one or more processing units 810, 815 and memory 820, 825. In FIG. 8, this basic configuration 830 is included within a dashed line. The processing units 810, 815 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 8 shows a central processing unit 810 as well as a graphics processing unit or co-processing unit 815. The tangible memory 820, 825 may be volatile memory (e.g., registers, cache, RAM), non-volatile memory (e.g., ROM, EEPROM, flash memory, etc.), or some combination of the two, accessible by the processing unit(s). The memory 820, 825 stores software 880 implementing one or more innovations described herein, in the form of computer-executable instructions suitable for execution by the processing unit(s).

A computing system may have additional features. For example, the computing system 800 includes storage 840, one or more input devices 850, one or more output devices 860, and one or more communication connections 870. An interconnection mechanism (not shown) such as a bus, controller, or network interconnects the components of the computing system 800. Typically, operating system software (not shown) provides an operating environment for other software executing in the computing system 800, and coordinates activities of the components of the computing system 800.

The tangible storage 840 may be removable or non-removable, and includes magnetic disks, magnetic tapes or cassettes, CD-ROMs, DVDs, or any other medium which can be used to store information in a non-transitory way and which can be accessed within the computing system 800. The storage 840 stores instructions for the software 880 implementing one or more innovations described herein.

The input device(s) 850 may be a touch input device such as a keyboard, mouse, pen, or trackball, a voice input device, a scanning device, or another device that provides input to the computing system 800. For video encoding, the input device(s) 850 may be a camera, video card, TV tuner card, or similar device that accepts video input in analog or digital form, or a CD-ROM or CD-RW that reads video samples into the computing system 800. The output device(s) 860 may be a display, printer, speaker, CD-writer, or another device that provides output from the computing system 800.

The communication connection(s) 870 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Cloud Computing Environment

FIG. 9 depicts an example cloud computing environment 900 in which the described technologies can be implemented. The cloud computing environment 900 comprises cloud computing services 910. The cloud computing services 910 can comprise various types of cloud computing resources, such as computer servers, data storage repositories, database resources, networking resources, etc. The cloud computing services 910 can be centrally located (e.g., provided by a data center of a business or organization) or distributed (e.g., provided by various computing resources located at different locations, such as different data centers and/or located in different cities or countries).

The cloud computing services 910 are utilized by various types of computing devices (e.g., client computing devices), such as computing devices 920, 922, and 924. For example, the computing devices (e.g., 920, 922, and 924) can be computers (e.g., desktop or laptop computers), mobile devices (e.g., tablet computers or smart phones), or other types of computing devices. For example, the computing devices (e.g., 920, 922, and 924) can utilize the cloud computing services 910 to perform computing operators (e.g., data processing, data storage, and the like).

### EXAMPLE IMPLEMENTATIONS

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (i.e., any available computing device, including smart phones or other mobile devices that include computing hardware). Computer-readable storage media are tangible media that can be accessed within a computing environment (one or more optical media discs such as DVD or CD, volatile memory (such as DRAM or SRAM), or nonvolatile memory (such as flash memory or hard drives)). By way of example and with reference to FIG. 8, computer-readable storage media include memory 820 and 825, and storage 840. The term computer-readable storage media does not include signals and carrier waves. In addition, the term computer-readable storage media does not include communication connections, such as 870.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A method, performed in a computing environment comprising at least one hardware processor and at least one memory coupled to the least one hardware processor, comprising:
receiving data stored in a computer-implemented data structure or data type, wherein the data is stored in a manner allowing column and row relationships in the data to be determined, wherein the data comprises a plurality of columns;
for each of multiple selected columns of the plurality of columns:
automatically generating implicit labels for supervised training for rows represented in the data structure or data type by treating, for each row, the value of the selected column as a target output; and
automatically training a supervised machine learning model distinct to the selected column and independent of supervised machine learning models for other columns of the plurality of columns using the values from other columns in a same row as input features and the value of the selected column in the same row as the target output.

2. The method of claim 1, further comprising:
selecting the multiple columns from the plurality of columns based on whether given columns of the plurality of columns satisfy data type criteria.

3. The method of claim 2, wherein columns with data types not satisfying the data type criteria are used as input features during the automatically training.

4. The method of claim 1, further comprising:
receiving a first request to predict a value of a first column of the multiple columns, the first request identifying the first column and providing values for at least a portion of other columns of the plurality of columns;
identifying a first machine learning model defined for the first column of the multiple columns;
submitting the values for at least a portion of other columns of the plurality of columns as input to the first machine learning model;
receiving a first result from the first machine learning model, the first result being a predicted value for the first column; and
returning the first result in response to the first request.

5. The method of claim 4, further comprising:
receiving user input to enter the first result as a value of the first column for a data set comprising the values for at least a portion of other columns of the plurality of columns; and
entering the first result in response to the user input.

6. The method of claim 4, further comprising:
determining a difference between the first result and a current value of the column and the values of the at least a portion of other columns of the plurality of columns.

7. The method of claim 4, further comprising:
receiving a second request to predict a value of a second column of the multiple columns, the second request identifying the second column and providing values for at least a portion of other columns of the plurality of columns;
identifying a second machine learning model defined for the second column of the multiple columns, wherein the second machine learning model is different than the first machine learning model;
submitting the values for at least a portion of columns of the plurality of columns other than the second column as input to the second machine learning model;
receiving a second result from the second machine learning model, the second result being a predicted value for the second column; and
returning the second result in response to the second request.

8. The method of claim 1, further comprising:
receiving request to predict a value of a first column of the multiple columns, the request identifying the column and providing values for at least a portion of other columns of the plurality of columns;
identifying a first machine learning model defined for the first column of the multiple models;
submitting the values for at least a portion of other columns of the plurality of columns as input to the first machine learning model;
receiving a result from the first machine learning model, the result being a predicted value for the first column; and
automatically entering the result as a value of the first column for a data set comprising the values for at least a portion of other columns of the plurality of columns.

9. The method of claim 8, wherein the automatically entering is carried out in response to automatically comparing a confidence value association with the result with a threshold and determining that the confidence value satisfies the threshold.

10. The method of claim 1, wherein the computer-implemented data structure or data type corresponds to a table and the data is master data.

11. A computing system comprising:
at least one hardware processor;
at least one memory coupled to the at least one hardware processor; and
one or more computer-readable storage media storing computer-executable instructions that, when executed, cause the computing system to perform operations comprising:
receiving data stored in a computer-implemented data structure or data type, wherein the data is stored in a manner allowing column and row relationships in the data to be determined, wherein the data comprises a plurality of columns;
for each of multiple selected columns of the plurality of columns:
automatically generating implicit labels for supervised training for rows represented in the data structure or data type by treating, for each row, the value of the selected column as a target output; and
automatically training a supervised machine learning model distinct to the selected column and independent of supervised machine learning models for other columns of the plurality of columns using the values from other columns in the same row as input features and the value of the selected column in the same row as the target output.

12. The computing system of claim 11, the operations further comprising:
receiving a first request to predict a value of a first column of the multiple columns, the first request identifying the first column and providing values for at least a portion of other columns of the plurality of columns;
identifying a first machine learning model defined for the first column of the multiple columns;
submitting the values for at least a portion of other columns of the plurality of columns as input to the first machine learning model;
receiving a first result from the first machine learning model, the first result being a predicted value for the first column; and
returning the first result in response to the first request.

13. The computing system of claim 12, the operations further comprising:
receiving user input to enter the first result as a value of the first column for a data set comprising the values for at least a portion of other columns of the plurality of columns; and
entering the first result in response to the user input.

14. The computing system of claim 12, the operations further comprising:
determining a difference between the first result and a current value of the column and the values of the at least a portion of other columns of the plurality of columns.

15. The computing system of claim 12, the operations further comprising:
receiving a second request to predict a value of a second column of the multiple columns, the second request identifying the second column and providing values for at least a portion of other columns of the plurality of columns;
identifying a second machine learning model defined for the second column of the multiple columns, wherein the second machine learning model is different than the first machine learning model;
submitting the values for at least a portion of columns of the plurality of columns other than the second column as input to the second machine learning model;
receiving a second result from the second machine learning model, the second result being a predicted value for the second column; and
returning the second result in response to the second request.

16. The computing system of claim 11, further comprising:
receiving request to predict a value of a first column of the multiple columns, the request identifying the column and providing values for at least a portion of other columns of the plurality of columns;
identifying a first machine learning model defined for the first column of the multiple models;
submitting the values for at least a portion of other columns of the plurality of columns as input to the first machine learning model;
receiving a result from the first machine learning model, the result being a predicted value for the first column; and
automatically entering the result as a value of the first column for a data set comprising the values for at least a portion of other columns of the plurality of columns.

17. The computing system of claim 16, wherein the automatically entering is carried out in response to automatically comparing a confidence value association with the result with a threshold and determining that the confidence value satisfies the threshold.

18. The computing system of claim 11, wherein the computer-implemented data structure or data type corresponds to a table.

19. One or more non-transitory computer-readable storage media comprising:
computer-executable instructions that, when executed by a computing system comprising at least one hardware processor and at least one memory coupled to the at least one hardware processor, cause the computing system to receive data stored in a computer-implemented data structure or data type, wherein the data is stored in a manner allowing column and row relationships in the data to be determined, wherein the data comprises a plurality of columns;
computer-executable instructions that, when executed by the computing system, cause the computing system to, for each of multiple selected columns of the plurality of columns:
automatically generate implicit labels for supervised training for rows represented in the data structure or data type by treating, for each row, the value of the selected column as a target output; and
automatically training a supervised machine learning model distinct to the selected column and independent of supervised machine learning models for other columns of the plurality of columns using the values from other columns in the same row as input features and the value of the selected column in the same row as the target output.

20. The one or more computer-readable storage media of claim 19, further comprising:
computer-executable instructions that, when executed by the computing system, cause the computing system to receive a first request to predict a value of a first column of the multiple columns, the first request identifying the first column and providing values for at least a portion of other columns of the plurality of columns;
computer-executable instructions that, when executed by the computing system, cause the computing system to identify a first machine learning model defined for the first column of the multiple columns;
computer-executable instructions that, when executed by the computing system, cause the computing system to submit the values for at least a portion of other columns of the plurality of columns as input to the first machine learning model;
computer-executable instructions that, when executed by the computing system, cause the computing system to receive a first result from the first machine learning model, the first result being a predicted value for the first column; and
computer-executable instructions that, when executed by the computing system, cause the computing system to return the first result in response to the first request.
